(19) United States
(12) Patent Application Publication
(10) Pub. No.: US 2026/0016836 A1
(43) Pub. Date: Jan. 15, 2026

(54) ROBOTIC CABLE LAYING SYSTEM FOR COMPLEX PATHS

(71) Applicant: NEC Corporation Of America, Herzlia (IL)

(72) Inventor: Tsvi LEV, Tel-Aviv (IL)

(73) Assignee: NEC Corporation Of America, Herzlia (IL)

(21) Appl. No.: 18/768,081

(22) Filed: Jul. 10, 2024

(51) Int. Cl. G05D 1/678; B64U 10/60; B64U 101/00; G02B 6/46; G05D 1/622; G05D 1/656; G05D 109/25

(52) U.S. Cl. CPC G05D 1/678; B64U 10/60; G02B 6/46; G05D 1/622; G05D 1/665; B64U 2101/00; G05D 2109/254

(57) ABSTRACT

A robot and method to lay cable from an unmanned aerial vehicle (“UAV”). The UAV adjusts its elevation and flight path to avoid obstacles on the ground and obstacles at elevation above the UAV and obstacles at elevation below the UAV.

### FIELD AND BACKGROUND OF THE INVENTION

The present invention, in some embodiments thereof, relates to a device and method of laying cables, more particularly, but not exclusively to aerial cable laying.

Additional background art includes U.S. Publication No. 2024/0033916A1, a robot unit adapted for performing telecommunications repair, powerline repair, general repair work, or other actions that may be performed by a robot. The robot unit may comprise one or more utility tools for performing actions such as sawing, cutting, screwing, wiring, or other actions associated with repair work adjacent to high powered electrical lines.

### SUMMARY OF THE INVENTION

According to an aspect of some embodiments of the present invention there is provided a method for laying cable on the surface of the ground with cable carried by a drone, comprising:
flying a drone along a flight path to lay cable at a predetermined altitude;
recognizing obstacles above the drone that define a ceiling of the flight path and below the flight path defining a floor for the flight path, adjusting the altitude;
recognizing flight path obstacles at the adjusted altitude and altering the flight path to avoid the flight path obstacles; and
laying the cable.

According to another aspect of some embodiments of the present invention there is provided a kit installed on the drone for laying cable on the surface of the ground comprising: a cable spool for light weight cable, a cable tensioner, and an anti-rotation mechanism; a controller, wherein the controller is in communication with the drone, cable cutter, and cable tensioner; and, one or more sensors in communication with the controller.

According to some embodiments of the invention the cable is optical fiber.

According to some embodiments of the invention the recognition of obstacles is by at least one sensor in communication with a controller.

According to some embodiments of the invention the one or more sensors are one or more of GPS, camera, LIDAR, IMU.

According to some embodiments of the invention the controller having a three dimensional (“3D”) map.

According to some embodiments of the invention the there is an additional step of tensioning the cable.

According to some embodiments of the invention an additional step of wrapping the cable around a ground based obstacle.

According to some embodiments of the invention the flight path is an initial flight path determined by a map to avoid ground based obstacles.

According to some embodiments of the invention the predetermined altitude is an initial altitude and is determined by a map of vegetative cover.

According to some embodiments of the invention, the controller controls the cable tensioner, the speed, altitude, pitch, yaw, and roll of the drone to establish a flight path and avoid obstacles.

According to some embodiments of the invention, the anti-rotation mechanism engages upon deceleration one of mechanically or in communication to the controller.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flow chart of an embodiment of the method;

FIG. 2 is a perspective view of a UAV;

FIG. 3A is a perspective view of laying the cable with ceiling A′-A′ and obstacle margins B′-B′ and C′-C′;

FIG. 3B is a plan top view of the path of laying a cable around ground based obstacles;

FIG. 4 is a perspective view of the UAV laying cable;

FIG. 5 is a plan top view of a cable wrapped around a ground based obstacle; and

FIG. 6 is a perspective view of a cable wrapped around a ground based obstacle.

### DESCRIPTION OF SPECIFIC EMBODIMENTS OF THE INVENTION

The present invention, in some embodiments thereof, relates to a device and method of laying cables, more particularly, but not exclusively to aerial cable laying.

The laying of cables for communications, sensing, perimeter marking, or power transmission is of great importance in industry, utilities, infrastructure setup. Common modern methods include laying on sea floor by ships, in trenches to be covered or tunnels under ground, and on top of existing elevated electrical/phone lines.

These methods are not suitable for an ‘unplanned’ rapid cable laying between two points which may be required in emergency. The present invention allows for example establishing a quick perimeter around a secure new facility/camp, establishing a fiber optic communication link to a new site such as a deployment or a disaster area.

The method can also be used to lay a power or communication cable alternative on top of damaged infrastructure (e.g., Electrical High Voltage line or underground cable damaged by bomb).

The method can be performed by guiding mechanisms such robots. Robots include Autonomously Guided Vehicles (“AGV”), or drones. The term drones include unmanned autonomous vehicles (“UAV”) and AGVs. Although the term robot is used, and can be used autonomously it is contemplated that the robot would be in communication with a user or user station.

Drones can be connected to a lightweight cable that they ‘drag’ behind them as they move and falls to the ground in time due to gravity if not under tensile forces. When the wire is spooled on board of the drone. A moving drone can continue moving even if the other side of the wire is rendered immobile.

Such drones/robots are configured with real time 3D sensing and mapping of the environment using any of a following: on board 3D mapping, on board LIDAR or similar 3D measuring apparatus, cameras enabling photogrammetry/3D reconstruction using the motion of the drone, and remote video transmission to a remote user center with human 3D estimation or server based 3D estimation.

Using a map of the flight area, a human or computer can plan in advance a desired path, made of a series of linear segments, including approximating curves, to reach the desired target point to form a path such as:
Avoiding entry into private properties/hostile areas;
Ground path is better protected from the elements (e.g., between trees, lower/higher than surrounding, dry, less visible, less exposed to winds);
Utilize the surface of the ground over existing infrastructure where available (electric power lines, over ground pipes, phone cables etc.);
Minimize overall distance/number of linear segments;

Additionally, at the vertices of the liner segments, there is some object that the cable can be tensioned and ‘wrapped around’ for stability and to effect a change in direction.

During the cable laying operation, the drone will fly in a path as per the pre-calculated and predetermined route. Speed and altitude will be predetermined configured for the cable to unspool and land on the desired points and to circumvent potential obstacles (e.g., power lines overhead, bridges)

The drone/AGV can monitor the cable laying below in real time and optionally raise tension the cable to raise the cable or change the position of the cable to avoid unforeseen issues.

When reaching a ‘vertex’ point, the drone will optionally use the local, real time 3D short range information to locate the obstacle such as a pole, building edge, tree or boulder around which the cable is to ‘turn’ to the next linear segment direction.

Around the vertex point, the drone may optionally just pass on the side and continue laying the cable, in which case the point will effect a change in the cable direction, but will not be a sticking or docking point for the cable. A sticking or docking point includes the wrapping described above. The drone may perform some ‘loops’ around the object or obstacle, using real time 3D acquisition and motion planning, such that several loops of the cable will surround the object, creating a sticking point, A sticking point includes a turning point. Then it will continue to lay the cable in the next linear segment.

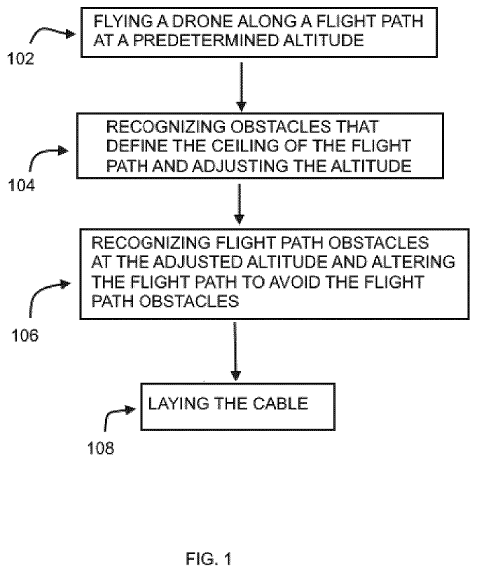

For purposes of better understanding some embodiments of the present invention, as illustrated in FIGS. 1-6 of the drawings, reference is first made to the construction and operation of an embodiment of the method illustrated in FIG. 1.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Referring now to the drawings, FIG. 1 illustrates an embodiment of the method, Step (102) the drone flies along a predetermined flight path and altitude. Recognizing obstacles (104) that define a ceiling of the flight path and adjusting the altitudes. The method also recognizes flight path obstacles (106) at the adjusted altitude altering the flight path to avoid the flight path obstacles. Along the adjusted altitude and flight path the UAV lays cable (108).

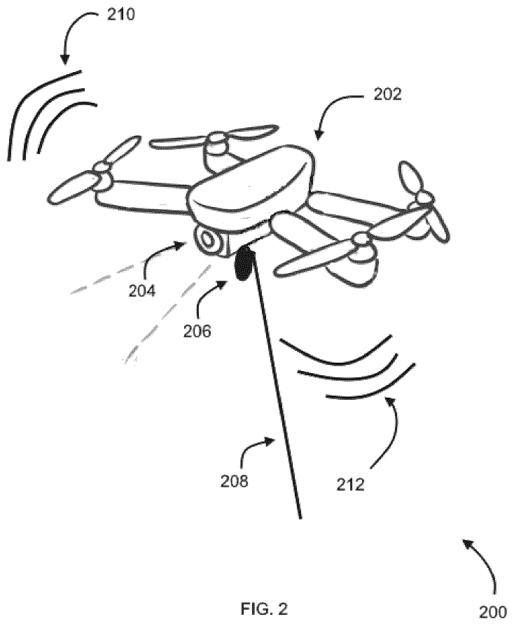

FIG. 2 is a perspective view of a UAV (202) with camera (204). The UAV (202) has a spool (206) with cable (208). The UAV has sensor including one or more of GPS, camera, LIDAR, IMU, accelerometer, and tension (not shown). The communication and sensors are represented by (210) and (212). The cable (208) is an optical fiber cable or other light weight cable, used for communications, marking an area or other purpose stated above.

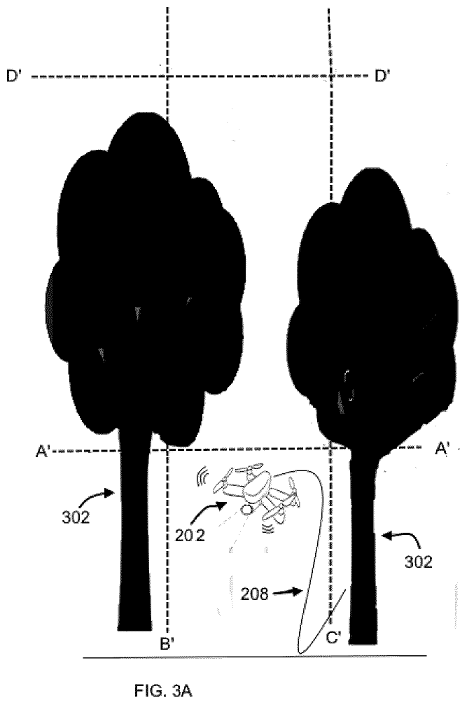

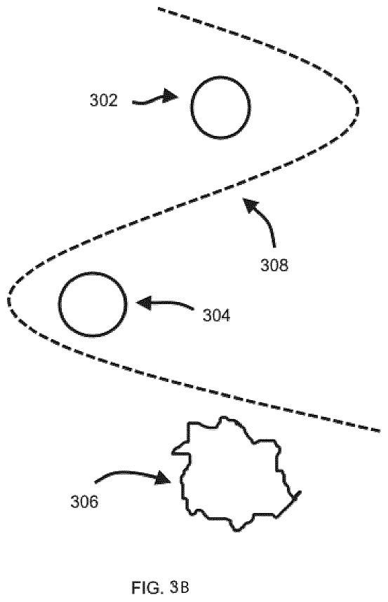

FIG. 3A is a perspective view of the UAV (202) laying cable (208) between obstacles (302) and (302). Broken line A′-A′ indicates a ceiling for the flight path that the UAV (202) adjusts in flight. Broken line D′-D′ indicates a floor for the flight path. Broken lines B-′B′ and C′-C′ are boundaries or margins to avoid the obstacles (302) and adjust the flight path. The recognizing of obstacle step of the method and the use of sensor data by the controller are used to avoid the obstacles. The method is cable of operating both below a ceiling or above a floor while laying cable (208) on the ground.

FIG. 3B is a top plan view of the cable path (308) as it is laid between obstacles (302), (304), and (306). The path (308) as shown by a broken line. The path can be referred to as linear in the sense that if follows from turning point to turning point. However, the path is calculated in linear segments and resembles curves.

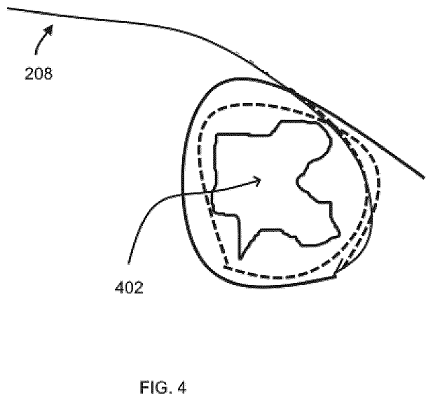

FIG. 4 is a top plan view of the cable shows a perspective view of the cable 208 wound around an obstacle 402. The loops or winding is done by the UAV (202) has tensioned the cable mechanically and optionally using a tension sensor to wind the cable 208 around the object. The object can be a tree, pole, boulder, building edge, or other object. The broken line indicates that the cable (208) is underneath the solid cable line (208).

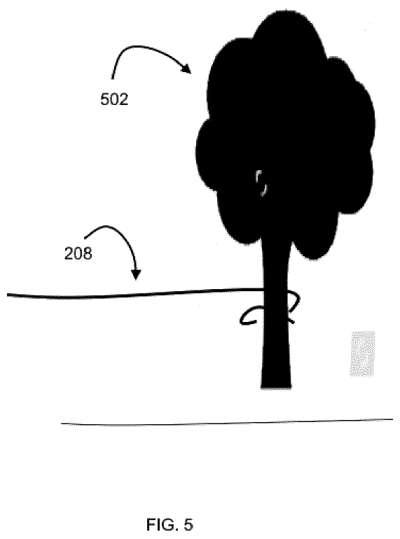

FIG. 5 is a perspective view of the cable 208 wound around and object. In this case a tree (502). The method as described above and show in plan view in FIG. 3B allows the cable (208) to be stabilized or change direction.

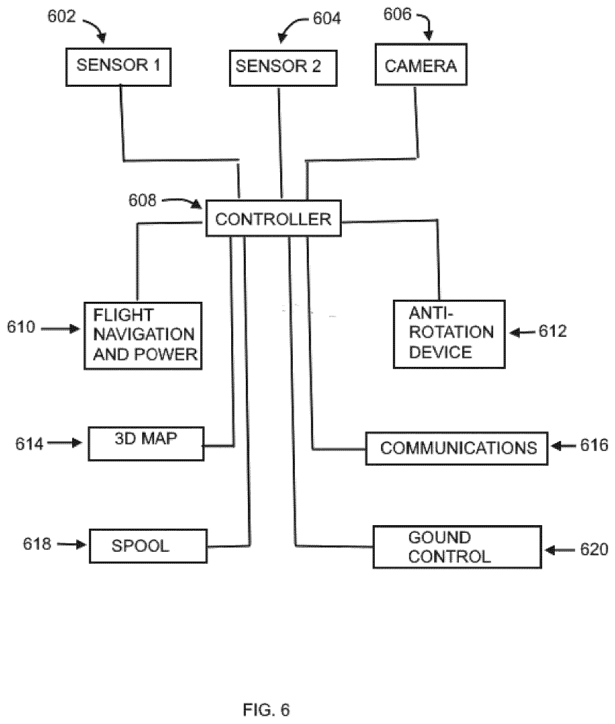

FIG. 6 is a block diagram of the control of the UAV (202). The UAV is controlled by a controller (608). It is in communication optionally with one or more sensors as described above, A camera is shown in this embodiment, The controller (608) is also shown in communication with a flight navigation and power package (610), 3D map (614), spool controls (618), communication (616), antirotation device (612) and ground control (620).

The controller (608) takes the sensor data and applies it to a flight and navigation control package 610) to control the altitude of the UAV (202) and its flight path. Flight Navigation and Power refers to the power applied to the rotors of the UAV and the UAV directional controls. The controller has a predetermined altitude and flight path, which can be referred to as an initial altitude and flight path. The 3D map (614) is used to establish position and direct the flight path.

The spool control (618) allows the spool to play out cable (208) and to tension the cable (208) so that it can be wound around objects or lifted and repositioned.

The communication package allows the UAV (202) to communicate with the ground control (620). Communication can be by radio, RF by any protocol.

It is expected that during the life of a patent maturing from this application many relevant ground based communications networks will be developed and the scope of the term robot cable laying is intended to include all such new technologies a priori

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention.

Certain features described in the context of various embodiments are not to be considered essential features of those embodiments, unless the embodiment is inoperative without those elements.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method for laying cable on the surface of the ground with cable carried by a drone, comprising:
flying a drone along a flight path to lay cable at a predetermined altitude;
recognizing obstacles above the drone that define a ceiling of the flight path and below the flight path defining a floor for the flight path, adjusting the altitude;
recognizing flight path obstacles at the adjusted altitude and altering the flight path to avoid the flight path obstacles; and
laying the cable on the ground.

2. A method according to claim 1, wherein the cable is optical fiber.

3. A method for laying cable according to claim 1, wherein the recognition of obstacles is by at least one sensor in communication with a controller.

4. A method for laying cable according to claim 3, wherein the one or more sensors are one or more of GPS, camera, LIDAR, IMU, accelerometer, and tension.

5. A method for laying cable according to claim 3, wherein the controller having a three dimensional (“3D”) map.

6. A method for laying cable according to claim 1, wherein there is an additional step of tensioning the cable.

7. A method for laying cable according to claim 6, wherein an additional step of wrapping the cable around a ground based obstacle.

8. A method for laying cable according to claim 1, wherein the flight path is an initial flight path determined by a map to avoid ground based obstacles.

9. A method for laying cable according to claim 1, wherein the predetermined altitude is an initial altitude and is determined by a map of vegetative cover.

10. A method for laying cable according to claim 1, wherein the predetermined altitude is a meter lower than median altitude of vegetative cover.

11. A kit installed on the drone for laying cable on the surface of the ground comprising:
a cable spool for light weight cable,
a cable tensioner,
an anti-rotation mechanism;
a controller, wherein the controller is in communication with the drone, cable cutter, and cable tensioner; and,
one or more sensors in communication with the controller.

12. A kit according to claim 11, wherein the lightweight cable is optical cable.

13. A kit according to claim 11, wherein the controller controls the cable tensioner, the speed, altitude, pitch, yaw, and roll of the drone to establish a flight path and avoid obstacles.

14. A kit according to claim 11, wherein the anti-rotation mechanism engages upon deceleration one of mechanically or in communication to the controller.
